(19) United States
(12) Patent Application Publication
(10) Pub. No.: US 2005/0096989 A1
(43) Pub. Date: May 5, 2005

(54) System for handling refunding of value-added tax

(75) Inventor: Markus Ostlund, Goteborg (SE)

Correspondence Address: HARNESS, DICKEY & PIERCE, P.L.C., P.O. BOX 828, BLOOMFIELD HILLS, MI, 48303, US

(73) Assignee: GLOBAL REFUND HOLDINGS AB, Molndal (SE)

(21) Appl. No.: 10/976,253

(22) Filed: Oct. 28, 2004

Related U.S. Application Data
(60) Provisional application No. 60/516,253, filed on Oct. 31, 2003.

(51) Int. Cl. G06F 17/60

(52) U.S. Cl. 705/19

(57) ABSTRACT

System for handling refunding of sales tax. The system comprises shop terminals (1,2,3) with credit card readers for purchase transactions via consumer's credit cards. The shop terminals (1,2,3) have means for input of purchase data and the system has programs for adding data generated by the system to purchase data. The shops have printers for purchase receipts and refund forms and said program controls printout of refund forms comprising detailed information about the purchase and corresponding refund of sales tax. The consumer's credit card number is registered in connection with the purchase and said program is arranged to check via the credit card number the consumers entitlement to refund of sales tax. Said program controls the debiting of the credit card and when the consumer is entitled to a refund of sales tax the credit card is debited with the total purchase amount minus an amount which is value-added tax minus a service fee. The program controls printout of a declaration, to be signed by the consumer, that he will carry out export of goods, have refund forms customs-stamped and ensure that stamped refund forms are delivered to a service company, which checks the customs-stamped refund form and returns the form to the shop, which in turn sends a list of purchases performed via the shop with entitlement to refund of sales tax to the tax authority of the country and receives a refund of sales tax from the authority. Said declaration includes information that the consumer agrees to a pre-determined amount being debited from the consumers credit card if the goods are not exported and said measures with the refund form are not performed.

The present invention concerns systems for handling of refunding of sales tax, such as value-added tax to a consumer who has purchased goods in another tax area than the area where he is resident, for example in another country than his country of residence.

### BACKGROUND ART

Persons who travel to another country than their country of residence may have the right to a refund of so-called value-added tax when they purchase goods or services abroad. This type of tax is found in many countries and the rate of tax can vary in different countries. In Europe the tax rate for most countries is over 10%. For example, the United Kingdom has so-called VAT (Value-added Tax) at 17.5% on most articles. In Sweden and Denmark this tax is as much as 25% but is somewhat lower for certain goods and services.

In Canada this tax on goods and services is 7% and certain provinces have a supplement for provincial taxes. In the USA most states have regional taxes in the order of 1-10%.

With the purpose of stimulating exports, these value-added taxes can in many countries be refunded to persons who are resident outside the country. A condition for this is that purchased goods are exported and used outside the country.

Hitherto, it has been very complicated for tourists and other visitors to a foreign country with value-added tax to obtain a refund of this tax. Ways of carrying out the refund vary between different countries. In some countries, visitors are allowed to apply for a refund when they leave the country, for example in transit areas at airports or near borders. However, the visitor must gather receipts and decide which purchases are entitled to a refund. The visitor must also complete forms in foreign languages, which forms must be checked by customs officials at the same time as the purchases must be presented. The visitor must thereafter queue at a refund counter and there receive the refund often in the currency of the country in question, which in turn means that the visitor must later stand in an exchange queue in order to receive his refund in the desired currency.

One example of a process for refunding value-added tax is practiced in Canada. According to this process, a person who has visited the country must post from outside the country a refund form together with original receipts for all purchases. Thereafter, it takes at least six weeks before the Canadian agent handles the case and sends the refund. The refund is paid in Canadian dollars and therefore when the visitor receives the cheque, he must also change it to the currency of his own country.

Another way of refunding value-added tax (VAT) is practiced in the United Kingdom. For each purchase for which a refund is possible, the visitor must prove his right to a refund by presenting his passport to the sales assistant. Certain retailers may also demand a minimum purchase before a refund can be received. The visitor must then in the shop complete a special refund form which is supplied by the retailer.

When the visitor leaves the European Community, all refund forms and 20 corresponding goods must be presented to a customs official and the visitor receives a customs stamp on the above-mentioned form. If the visitor neglects to certify the refund form at the customs, he will have no further opportunity of receiving a refund.

Once outside the European Community, the visitor must post a customs-25 stamped refund form to each shop where the person made a purchase. The retailer will then deduct a fee and send a cheque in Euros for the remaining amount to the customer, who then can change it to a currency that can be used in his homeland.

Other countries have other special rules that must be fulfilled in order to obtain a refund of value-added tax.

As can be seen from the above, it is possible for individuals to receive a refund of value-added tax which has been paid on purchasing goods in foreign countries. However, as has been seen, this is extremely complicated for certain countries. Furthermore, the rules vary, which makes it considerably more difficult for persons visiting several countries during a trip.

The purpose of enabling value-added tax to be refunded to people who are resident in another country is of course to try to stimulate export of goods. With the aim of preventing tax fraud, different countries have chosen, as has been exemplified above, to introduce different rules which must be met in order to allow foreign visitors to receive refunds of value-added tax.

There exist service companies, which have set up businesses to enable easier handling of refunds of value-added tax for both tourists and shops. In shops which are collaborating with these service companies, tourists are given refund forms which have to be completed with certain personal details. Goods and forms are presented at customs and forms are provided with the requisite customs stamp. The above-mentioned companies have service points at international airports and at border stations where tourists can obtain their refund directly in the desired currency. The company then takes care of all paperwork and bills the shops. The service company charges a fee for its services, which represents a percentage of the purchase sum.

If a customer forgets or does not have time to visit the above-mentioned service points for refunding value-added tax, the customer can also send the requisite documents to the service company afterwards. The service company can then, with the aid of the documents, deposit the tax refund in the customer's bank account or the like.

These service companies considerably simplify the procedure for tourists and doubtless considerably stimulate sales for the participating shops. However, there is a need for further simplification for both shop-owners and tourists

There is still a great deal of time-consuming paperwork for the shops, which, for each new customer who is perceived to be a tourist or states himself to be a tourist, must furnish refund forms and in addition must explain to the tourist how to fill them in. This time-consuming practice reduces the flow of paying customers through the shop and there is a great need to simplify the routines and reduce the paperwork.

WO 00/42546 suggests a system for simplifying the refunding of value-added 10 tax. The said system comprises an advanced transaction card, which is intended to cooperate with card terminals to execute the purchase transaction and generate transaction data. An application for a tax refund is stored directly on the transaction card, which is arranged to calculate the tax refund corresponding to the entered purchase data. However, the system suggested in WO 00/42546 is not realistic because it does not take into account the requirements of different countries for checking of transactions regarding refunding of tax. Essential data, such as the cardholder's passport number and home address, is also difficult to store on the transaction card since these details must be able to be changed, for example if the card holder changes his home address. For the individual consumer it is regarded to be inconvenient to have yet another “credit card” to look after and carry with one on trips abroad.

A further problem with the system described above where refund forms provided with customs stamps are presented at a refund point for payment of a refund is that it is impossible for the service company to check the accuracy of the purchase amount, which could have been manipulated. It is not possible to check for fraud and to what extent it occurs.

Another problem is that with the present system it takes a long time before the consumers receive their refund. The consumers'means are temporarily reduced by the amount of the sales tax charged on the purchase. If the consumer pays by credit card, the card issuer charges a percentage of the entire purchase sum, i.e. including sales tax. If a consumer purchases capital goods for large sums, the consumer's spending power can be temporarily considerably reduced, which is also disadvantageous for shops.

As is evident from the above, there is a great need, from the point of view of both retailers and consumers, to improve the present system for refunding value-added tax to tourists.

### DISCLOSURE OF INVENTION

The present invention is characterized in that the system comprises shop terminals which have credit card readers and which are connected via networks to financial institutes, such as banks, in order to carry out purchase transactions via consumer' credit cards, that said terminals are provided with means for input of purchase data for each respective purchase occasion, that the system has programs for adding data generated by the system, such as calculation of sales tax for the purchase in question, to said purchase data, that shops connected to the system have printers for purchase receipts and refund forms, that said program controls printout of refund forms comprising detailed information about the purchase and corresponding refund of sales tax, that the consumer's credit card number is registered in a shop terminal by means of said credit card reader in connection with the purchase, that said program is arranged to check via the consumers credit card number if the consumer is entitled to a refund of sales tax, that said program controls the debiting of the credit card and, when the consumer is entitled to a refund of sales tax, the credit card is debited with the total purchase amount minus an amount which is sales tax minus a service fee and that the program controls the printout of a declaration, to be signed by the consumer, that he will carry out export of goods, have refund forms customs-stamped and ensure that stamped refund forms are delivered to a service company, which, in exchange for said service fee, checks the stamped refund form and returns the form to the shop, which in turn sends a list of purchases performed via the shop with entitlement to refund of sales tax to the tax-authority of the country and receives from the authority a sum of money corresponding to the sales tax with entitlement to a refund that has been paid, and additionally, said declaration includes information that the consumer agrees to a pre-determined amount corresponding to at least the sales tax being debited from the consumer's credit card if the goods are not exported and said measures with the refund form are not performed by the consumer within a fixed period.

With the system in accordance with the invention, a consumer receives his refund of sales tax immediately in connection with a purchase. A purchase receipt for the total price of the purchase, i.e. including sales tax, is printed out. However, when the consumers credit card is debited only the price of the goods and a service fee are charged and not the sales tax. The consumer keeps the money, the value-added tax minus the service fee, in his account and thus has increased liquidity and, in addition, the fee charged by the bank that issues the credit card will not have to be paid on sales tax.

The system in accordance with the invention will also be safer than previous systems where the sales tax is refunded afterwards when the consumer has left the country. When the refund is carried out in the shop in direct connection with the purchase, there is no opportunity for fraud, i.e. manipulation of the amount of the refund. When the refund is carried out at a later date, it is possible for someone to fake the stated price and refund amount.

According to one embodiment, the invention is characterized in that the said program is arranged to check if, in connection with the purchase, an immediate deduction of the refund amount can be made from the purchase price, said check comprising at least a check that the consumers credit card has a validity period extending a fixed period of time from the purchase occasion, which period of time is longer than the fixed period within which the consumer shall have carried out said measures.

According to another embodiment, the invention is characterized in that the system comprises a central database which, via a network, is connected to shop terminals included in the system, that the system comprises computer programs to create an identification reference which is common to each respective receipt with associated refund form and declaration and to state said identification reference on the receipt, refund form and declaration, and that the system is arranged to electronically store the receipt, refund form and declaration in the database.

According to a further embodiment, the system in accordance with the invention is characterized in that said identification reference comprises one or more identification details, such as identification numbers for, for example, a shop, shop terminal and country.

### DESCRIPTION OF THE FIGURES

The invention will be described below in greater detail with reference to the embodiments shown in the attached figures. In which:

FIG. 1 shows schematically a first embodiment of the system in accordance with the invention.

FIG. 2 shows schematically a second embodiment of the system in accordance with the invention.

FIGS. 3-6 show flow charts for the process steps included in the system in the embodiment in accordance with FIG. 1.

### EMBODIMENTS OF THE INVENTION

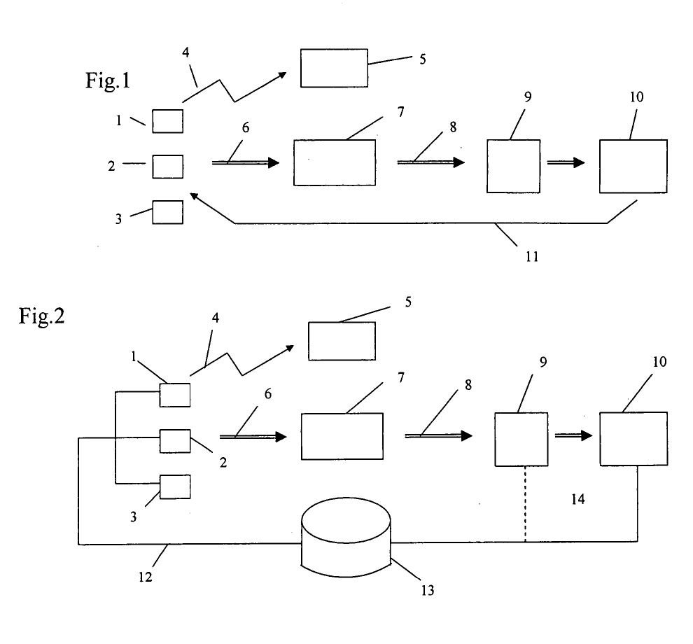

FIG. 1 shows a number of shop terminals, 1, 2 and 3, which are connected to a system in accordance with the invention and which here represent shop terminals in different shops in one country.

The shop terminals 1, 2 and 3 have credit card readers and are connected via networks 4 to financial institutes, such as card-issuing banks 5, in order to carry out purchase transactions via. consumers' credit cards. The terminals 1, 2 and 3 are provided with means for input of purchase data for each respective purchase occasion, which means can be, for example electronic cash registers. The system has programs for adding data generated by the system, such as calculation of sales tax for the purchase in question, to said purchase data. Shops connected to the system have printers for purchase receipts and refund forms. Purchase receipts can be printed out in the customary way on cash registers and refund forms can be printed via a separate printer. Alternatively, shops can have a common printer for both receipts and refund forms. Said program is arranged to control printout of refund forms comprising detailed information about the purchase and corresponding refund of sales tax. Said program is also arranged to provide refund forms with customary areas for inscription of personal details, such as the customers name, address and passport number, which areas are completed by the consumer before passing through customs.

Said program is arranged to check via the consumers credit card number whether the customer is entitled to a refund of sales tax. When the credit card is read a check can also be made via the network 4 and the card-issuing bank as to whether the necessary amount for the purchase is available via the credit card. The expiry date of the card can also be checked either manually or by scanning. A condition for receiving immediate refund of sales tax is that the period of validity of the card extends for a fixed period of time from the purchase occasion. Said program is arranged to control the printout of a declaration, to be signed by the consumer, that he will carry out export of purchased goods, have refund forms customs-stamped and ensure that stamped refund forms are delivered to a service company, which in exchange for a service fee, checks the stamped refund form and returns the form to the shop. The retailer sends a list of purchases performed via the shop with entitlement to refund of sales tax to the tax-authority of the country and receives from the authority a sum of money corresponding to the sales tax paid.

Said declaration includes information that the consumer agrees to a predetermined amount corresponding to at least the value-added tax being debited from the consumers credit card if the goods are not exported and said measures with the refund form are not performed by the consumer within a fixed period. This fixed period can be a month, provided of course that the expiry date of the card is more than a month from the time of purchase.

In FIG. 1 the arrow 6 illustrates that the consumer goes to a customs station 7, where goods and refund forms completed with personal details and passport number are presented together with passports and where the refund forms are customs-stamped if the customs find that the conditions for refund of value-added tax have been fulfilled.

After the customs inspection, as illustrated by arrow 8, the consumer goes to a service point 9, which is run by said service company at airports and near borders, if the border is being crossed in a different way. The consumer hands in the customs-stamped refund form at the service point from where the staff send the refund form to the service company's back office 10, where the form is checked and from where the form is sent to the shop in question, as is illustrated by the arrow 11. From the back office, shops are also invoiced for a service fee which is charged by the service company for each purchase transaction.

The embodiment shown in FIG. 1 is greatly simplified for the sake of clarity. The aim is of course that terminals in a great number of shops and warehouses in different countries shall be connected to the system just as the current system is part of an international flow.

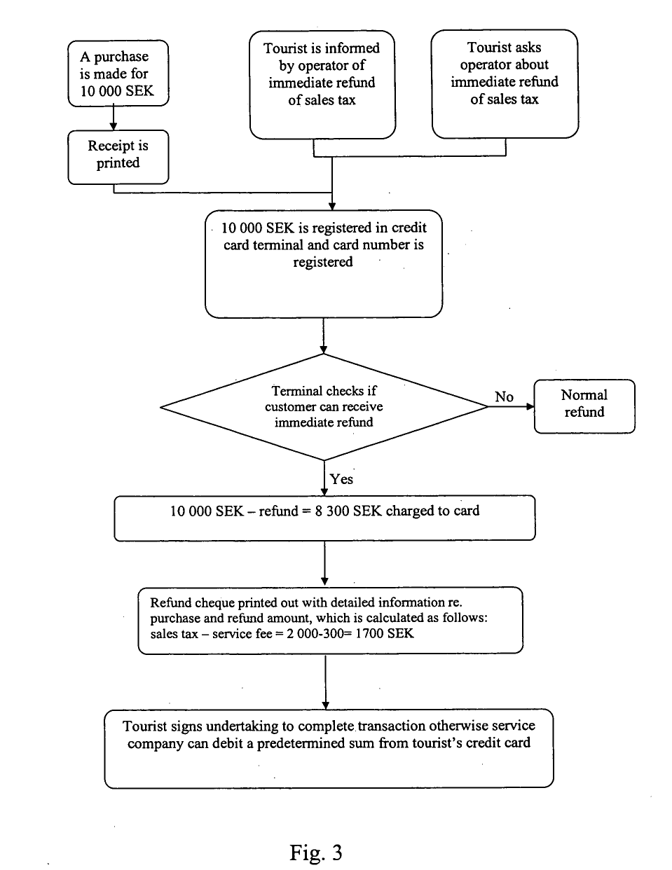

The system flow in the embodiment in accordance with FIG. 1 is described in more detail below with reference to FIGS. 3-6.

In the embodiment in accordance with FIG. 2, parts corresponding to similar details in FIG. 1 have been given the same reference numerals. The essential difference from the embodiment in FIG. 1 is that the shop terminals are connected via a second network 12 to a central database 13 which belongs to the system in this embodiment, in which all purchase transactions in the form of receipts, refund forms and declarations are stored. For the sake of clarity, in FIG. 2 the database 13 is shown separately and separated from the back office. However, the central database is suitably placed in the back office. As illustrated by the broken line 14, the service points 9 can also be connected to the database.

For the embodiment in accordance with FIG. 2, said computer programs belonging to the system are arranged to create an identification reference for each purchase transaction, which reference is common to each respective receipt and its corresponding refund form and declaration. The computer program is arranged to state said identification reference on the receipt, refund form and declaration before they are printed and before they are stored in the database.

Suitably, these identification references will include one or more identification details, such as identification numbers, for, for example, the shop, shop terminal and country.

The consumer carries out the same steps as are described in connection with the embodiment in accordance with FIG. 1 and finally hands in the customs-stamped refund form to the service point 9. From the service point, also called the collection point for refund forms in the flow charts shown in FIGS. 3-6, the refund form is then sent to the back office. From the back office information is stored in the database 13 when a refund form has come in. From the back office an invoice is sent via the network 12 to shops together with a list of refund forms which have come in during the most recent period. What is invoiced to the shop is the difference between the total value-added tax paid and the total refund to the clients.

The shop uses the list to declare value-added tax to the tax authority and thus receives money from the state. Computer programs forming part of the system in accordance with FIG. 2 are suitably programmed to provide the shops at intervals with lists of non-returned forms and the shops can then charge fixed amounts in accordance with the declaration from the accounts of the customers in question.

As is described in FIG. 3, the consumer makes purchases in the form of one 15 or more items for a total of 10000 SEK. When the credit card is swiped in the credit card terminal the computer program is activated in the system for necessary checks as to whether the customer is entitled to an immediate refund, constituted of value-added tax minus a service fee. In the shown embodiment the service fee is 3% of the total purchase price, i.e. of the item/items plus value-added tax. A check is also carried out as to whether the card is valid for the necessary period after the purchase occasion.

FIG. 3 describes the process in connection with the purchase in the shop.

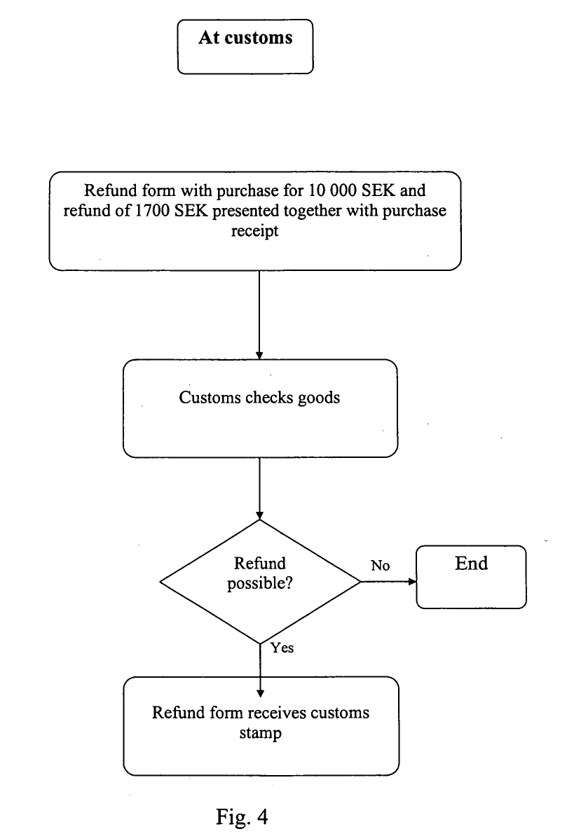

FIG. 4 describes the process at customs.

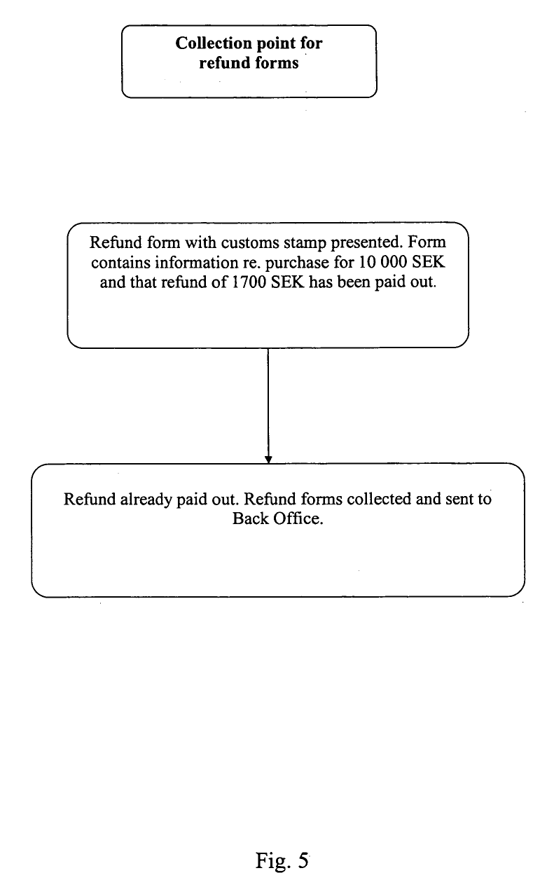

FIG. 5 describes the process at the collection point for refund forms.

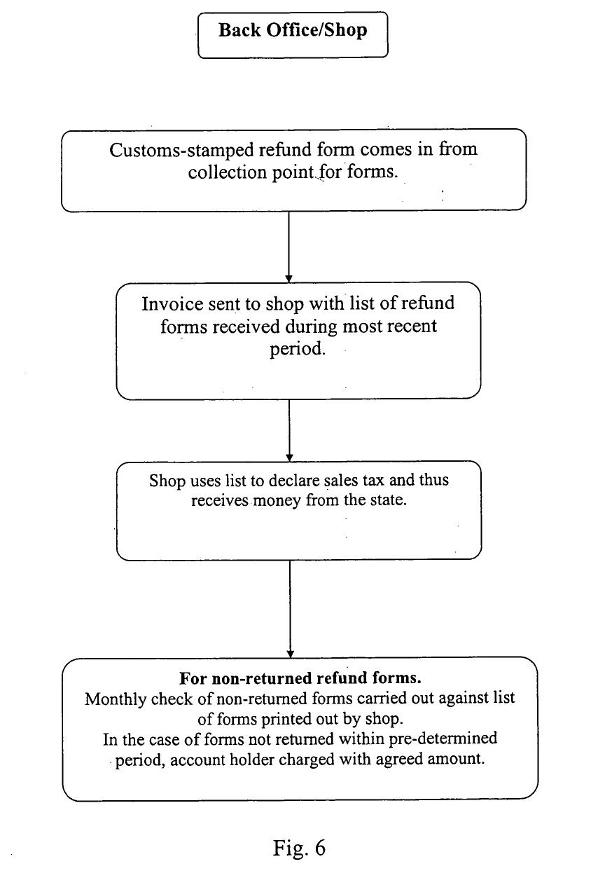

FIG. 6 describes the process in the back office and the subsequent process in the shop.

The invention is not limited to the above embodiments. Several modifications are possible within the framework of the following claims.

1. System for handling of refunding of sales tax, such as value-added tax to a consumer who has purchased goods in another tax area than the area where he is resident, for example in another country than his country of residence, characterized in that the system comprises shop terminals (1, 2, 3) which have credit card readers and which are connected via networks (4) to financial institutes, such as banks (5), in order to carry out purchase transactions via consumers' credit cards, that said terminals (1, 2, 3) are provided with means for input of purchase data for each respective purchase occasion, that the system has programs for adding data generated by the system, such as calculation of sales tax for the purchase in question, to said purchase data, that shops connected to the system have printers for purchase receipts and refund forms, that said program is arranged to control printout of refund forms comprising detailed information about the purchase and corresponding refund of sales tax, that the consumer's credit card number is registered in a shop terminal by means of said credit card reader in connection with the purchase, that said program is arranged to check via the consumers credit card number if the consumer is entitled to a refund of sales tax, that said program controls the debiting of the credit card and, when the consumer is entitled to a refund of sales tax, the credit card is debited with the total purchase amount minus an amount which is sales tax minus a service fee and that the program controls the printout of a declaration, to be signed by the consumer, that he will carry out export of goods, have refund forms customs-stamped and ensure that stamped refund forms are delivered to a service company, which, in exchange for said service fee, checks the stamped refund form and returns the form to the shop, which in turn sends a list of purchases performed via the shop with entitlement to refund of sales tax to the tax-authority of the country and receives from the authority a sum of money corresponding to the sales tax with entitlement to a refund that has been paid, and additionally, said declaration includes information that the consumer agrees to a pre-determined amount corresponding to at least the sales tax being debited from the consumer's credit card if the goods are not exported and said measures with the refund form are not performed by the consumer within a fixed period.

2. System in accordance with claim 1,
characterized in that said program is arranged to check if, in connection with the purchase, an immediate deduction of the refund amount can be made from the purchase price, said check comprising at least a check that the consumer's credit card has a validity period extending a fixed period of time from the purchase occasion, which period of time is longer than the fixed period within which the consumer shall have carried out said measures.

3. System in accordance with claim 1 or 2,
characterized in that the system comprises a central database (13) which, via a network (12), is connected to shop terminals (1, 2, 3) included in the system, that the system comprises computer programs to create an identification reference which is common to each respective receipt with associated refund form and declaration and to state said identification reference on the receipt, refund form and declaration, and that the system is arranged to thereafter electronically store the receipt, refund form and declaration in the database.

4. System in accordance with claim 3,
characterized in that said identification reference comprises one or more identification details, such as identification numbers for, for example, a shop, shop terminal and country.
